(19) United States
(12) Patent Application Publication
(10) Pub. No.: US 2012/0209954 A1
(43) Pub. Date: Aug. 16, 2012

(54) Systems and Methods for Online Session Sharing

(76) Inventor: John W. Wright, Provo, UT (US)

(21) Appl. No.: 13/396,519

(22) Filed: Feb. 14, 2012

Related U.S. Application Data
(60) Provisional application No. 61/443,208, filed on Feb. 15, 2011.

(51) Int. Cl. G06F 15/16

(52) U.S. Cl. 709/217

(57) ABSTRACT

Computer-implemented systems and method for sharing online information, such as browser sessions, between computer systems monitor information at a leader computer related to a status of the leader computer, pass a uniform resource locator (URL) associated with a status of the leader computer from the leader computer to a follower computer over a computer network, and automatically cause a browser window at the follower computer to be directed to the URL upon receipt of the URL over the computer network. Thus, a communicative leader-follower session is established between remote computers such that a follower browser follows a leader browser through various websites, thereby allowing sharing of the website history between computers. Many additional features and functionalities may be provided, while the total amount of data communicated between the computers is kept to a minimum.

### CROSS-REFERENCE TO RELATED APPLICATIONS

This application claims the benefit of U.S. Provisional Application No. 61/443,208, filed Feb. 15, 2011.

### BACKGROUND OF THE INVENTION

1. Field of the Invention

The present invention relates to sharing of information over networks such as the Internet, and more particularly to systems and methods for online session sharing.

2. Background and Related Art

Throughout history, people who have needed to share information have utilized various methods to do so. When people are physically close to each other, the sharing of information can be relatively simple, with one person simply entering the physical presence of one or more others and sharing information orally (talking), visually, or otherwise. Sharing of information becomes more difficult as the physical distance between persons increases. In the past, sharing of information between remote individuals required either that one or more of the individuals either physically traverse the distance separating the remote individuals or that a messenger or service physically takes some sort of communication (e.g. physical mail) between the individuals.

Over time, the advent of technology has permitted and facilitated other manners of communication of information. For example, the telegraph and telephone allowed individuals separated by even great distances to communicate much information, although the communicated information could be limited to largely information that could be communicated orally. More complex information such as pictures and other communications could not be communicated using such methods. The advent of mass media such as radio and, eventually, television opened new manners of communication, allowing point-to-many communication methods over distance and in a rapid way that provided benefits not available to then-traditional mass media such as newspapers, books, and the like.

While such communication methods provided many advantages, there were still significant limits imposed by the technologies. Among these is the fact that some of the point-to-many communications techniques enabled by radio and television communication are difficult to direct to a particular group of people while excluding unwanted individuals. Thus, even though schemes are available to provide encryption and the like to such communications to limit the audience of such communications techniques, radio and television have largely remained public communications media.

Another limitation of these mass media techniques is that the communications are largely or entirely one-way types of communication. In many instances, it is desirable to permit two-way and multi-way communications between individuals to permit collaboration and the like between physically-separated individuals in a way that is largely not addressed by traditional mass media techniques. Telephone conferencing and video-conferencing have sought to address such needs to some extent, but have proven unsatisfactory in many regards, including technological demands and limitations on communications bandwidth with traditional communications networks.

The advent of wide area networks such as the Internet, along with other technological improvements in computers, cell phones, and smart phones, have opened up new avenues for sharing information between individuals. E-mail and other messaging systems permit the directed exchange of many types of information between desired individuals and groups in ways not previously available. Additional point-to-many types of communication, including near-real-time communication have been made available over the Internet. For example, websites such as news websites are increasingly popular sources of news and other information, and are available to immediately share breaking news in print, pictures, and near-real-time video with many users.

Such websites and information sources are still limited in that they are not readily able for two-way and multi-way sharing of information. Such information sharing is often desirable to provide or mimic the sharing of information that can occur face-to-face, such as in meetings. Innovations have been provided to address such desires and provide information sharing in ways not readily available even through interactive websites. Entities and services such as GoToMeeting, WebEx, DimDim, and others have attempted to provide alternative mechanisms for sharing information.

In a typical instance of using such providers' services, a program installation occurs on a user's computer to install the provider's program. When the program is active on a local computer, it provides a window on the local computer (that may or may not fill a local display screen) that displays near-real-time information from a remote computer as desired by a presenter or the like. As one typical example, the presenter's entire remote display screen is displayed on the local computer, essentially as it is viewed by the presenter. To facilitate this, several things typically occur: 1) the presenter's remote display screen and the local computer's display screen resolution(s) may be adjusted to a compatible size, and 2) the presenter's display information is streamed to the local computer. If an audio connection is desired between locations, it can be provided by the presentation program (as additional streamed information), or an existing telecommunications network system (e.g. a conference call, etc.) may be used to provide the audio connection. In some instances, systems such as these even permit a user in a remote location to “take over” and control a remote computer as part of the information exchange and/or to permit changing of the person deemed the “presenter.”

While such systems often function well, address many existing needs, and provide good flexibility in the types of information that may be shared between remote locations, there are significant limitations. For example and as discussed above, the systems often require altering the resolution of one or more computer screens to a sub-optimal resolution. Additionally, the amount of information being streamed from one computer to the next can be quite large and serves as a limit on the number of computers that can be readily connected to receive shared information. For example, the provider of the GoToMeeting solution currently offers various levels of subscriptions to its users, with a basic subscription allowing up to 15 simultaneous attendees to any meeting for around $50 (fifty (U.S.) dollars) per subscription, with the subscription price increasing per the maximum number of attendees to around $100 (one hundred dollars) for up to one hundred attendees, to around $400 (four hundred dollars) per subscription for up to five hundred attendees, and to around $500 (five hundred dollars) per subscription for up to one thousand attendees.

Such a pricing structure is essentially a fact of life with providers of these solutions in order to allow the providers to provide enough server capacity to meet peak demand, even if peak demand is only rarely, if ever, reached by a particular subscriber. As may be appreciated from the above-described pricing structure, the cost of such implementations can be high, and can be especially high for companies and other entities that may need to have multiple accounts to permit different groups or individuals to initiate online meetings. As an illustrative example, a network marketing business is inherently arranged in a hierarchical structure of networked authority, and it is common for the need to arrange a meeting of the type described above to be felt by even individuals well down in the hierarchy. Thus, such a business might need hundreds of subscriptions, many of which would only get light use, at a significant cost to the business's bottom line.

Thus, while continued innovation has provided significant advances in systems and methods for sharing information, significant barriers and difficulties still exist that limit the effective sharing of information.

### BRIEF SUMMARY OF THE INVENTION

Implementation of the invention provides computer-implemented systems and methods for sharing online information, including browser sessions, between computer systems. One method includes monitoring information at a leader computer related to a status of the leader computer, passing a uniform resource locator (URL) associated with a status of the leader computer from the leader computer to a follower computer over a computer network, and automatically causing a browser window at the follower computer to be directed to the URL upon receipt of the URL over the computer network.

Another method includes establishing a communicative leader-follower session between remote computer systems over a network, wherein a browser window on a first computer system of the remote computer systems becomes a leader browser, and wherein a browser window on a second computer system of the remote computer systems becomes a follower browser. Thereafter, the leader browser window is monitored for inputs changing a URL being accessed by the leader browser, and an input changing the URL being accessed by the leader browser to a new URL is detected. The new URL is automatically communicated over the network to the second computer system, and the follower browser is automatically caused to access the new URL upon receipt of the new URL by the second computer system.

Implementation of the invention includes systems and non-tangible computer-readable media storing computer program code to cause implementation of the methods discussed above. Many additional features and functionalities of certain implementations of the invention will be described in more detail herein or will be appreciated from the practice of the various implementations of the invention. Thus, the foregoing summary is intended to be illustrative and not limiting of the invention.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system that is illustrative of the principles of computer systems that may be used with embodiments of the invention;

FIG. 2 shows a representative networked computer system that is illustrative of the principles of networked computer systems that may be used with embodiments of the invention;

FIG. 3 shows a representation of a web browser window;

FIG. 4 shows a representation of a web browser window directed to a site for downloading a browser extension in accordance with embodiments of the invention;

FIG. 5 shows a representation of a web browser window with a browser extension installed in the browser;

FIG. 6 shows a representative flow of operations in accordance with practice of embodiments of the invention;

FIG. 7 shows representative displays that may be provided by embodiments of the invention upon selection of the browser extension; and

FIGS. 8-15 show representative displays that might be provided by embodiments of the invention to access features of the embodiments.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide computer-implemented systems and methods for sharing online information, including browser sessions, between computer systems. One method includes monitoring information at a leader computer related to a status of the leader computer, passing a uniform resource locator (URL) associated with a status of the leader computer from the leader computer to a follower computer over a computer network, and automatically causing a browser window at the follower computer to be directed to the URL upon receipt of the URL over the computer network.

Another method includes establishing a communicative leader-follower session between remote computer systems over a network, wherein a browser window on a first computer system of the remote computer systems becomes a leader browser, and wherein a browser window on a second computer system of the remote computer systems becomes a follower browser. Thereafter, the leader browser window is monitored for inputs changing a URL being accessed by the leader browser, and an input changing the URL being accessed by the leader browser to a new URL is detected. The new URL is automatically communicated over the network to the second computer system, and the follower browser is automatically caused to access the new URL upon receipt of the new URL by the second computer system.

Embodiments of the invention include systems and non-tangible computer-readable media storing computer program code to cause implementation of the methods discussed herein. Many additional features and functionalities of certain embodiments of the invention will be described in more detail herein or will be appreciated from the practice of the various embodiments of the invention.

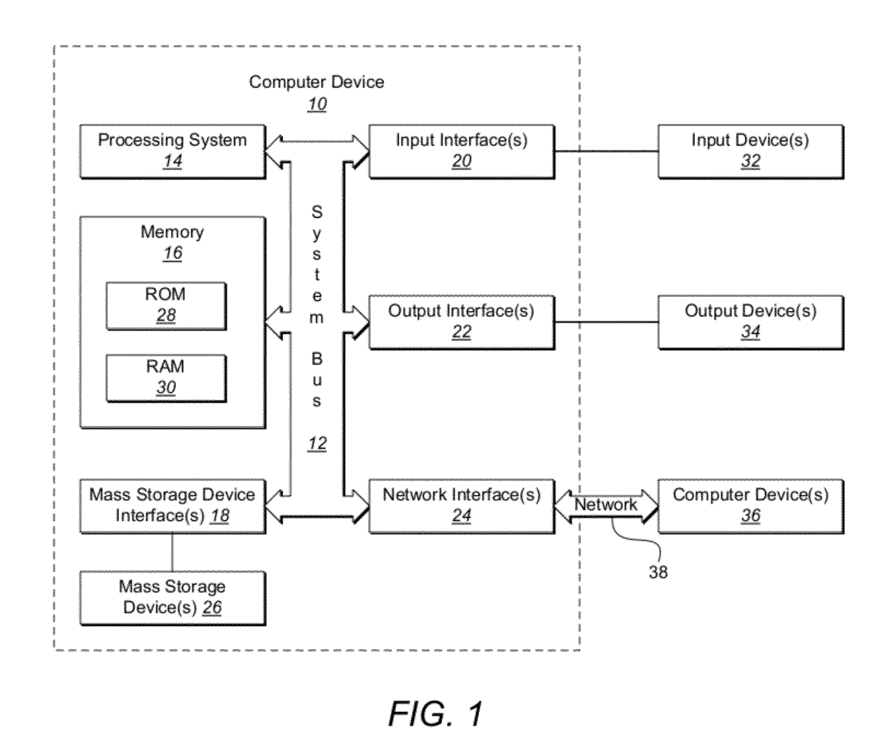

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

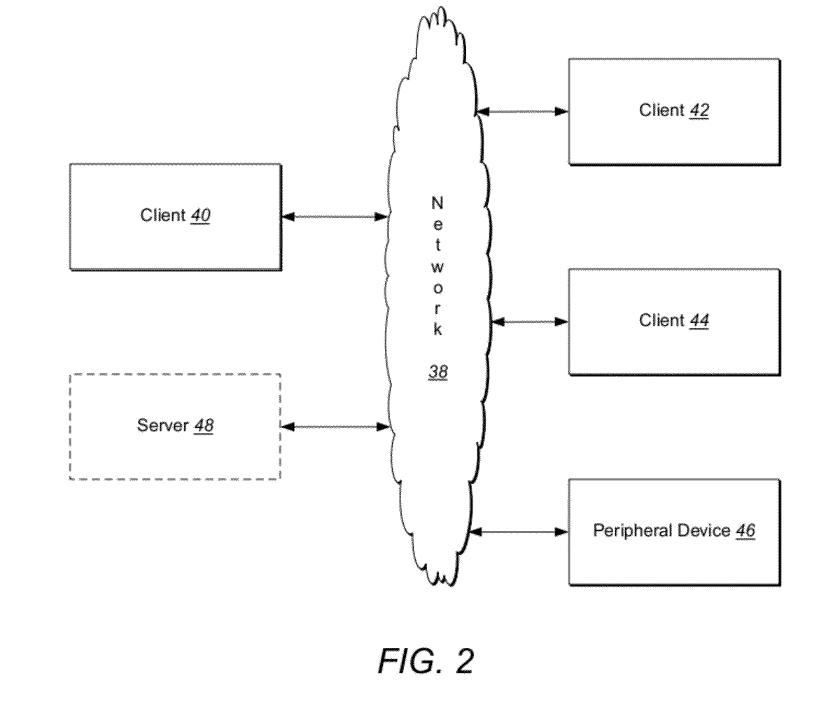

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients (including many clients), more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace the use of electronic consumer devices, wireless networked environments, and/or wide area networked environments, such as the Internet.

While existing online meeting providers typically utilize a large installed program and streaming of significant amounts of information from a presenter's computer to various remote viewing computers, embodiments of the invention minimize an installation and further minimize the amount of information transferred to linked computers. Embodiments of the invention provide many features and advantages that will be appealing to many users. While existing online collaboration programs and tools provide functionality and advantages that will still be available after adoption of embodiments of the invention, it is envisioned that embodiments of the invention may efficiently supplant many of the features provided by such existing programs.

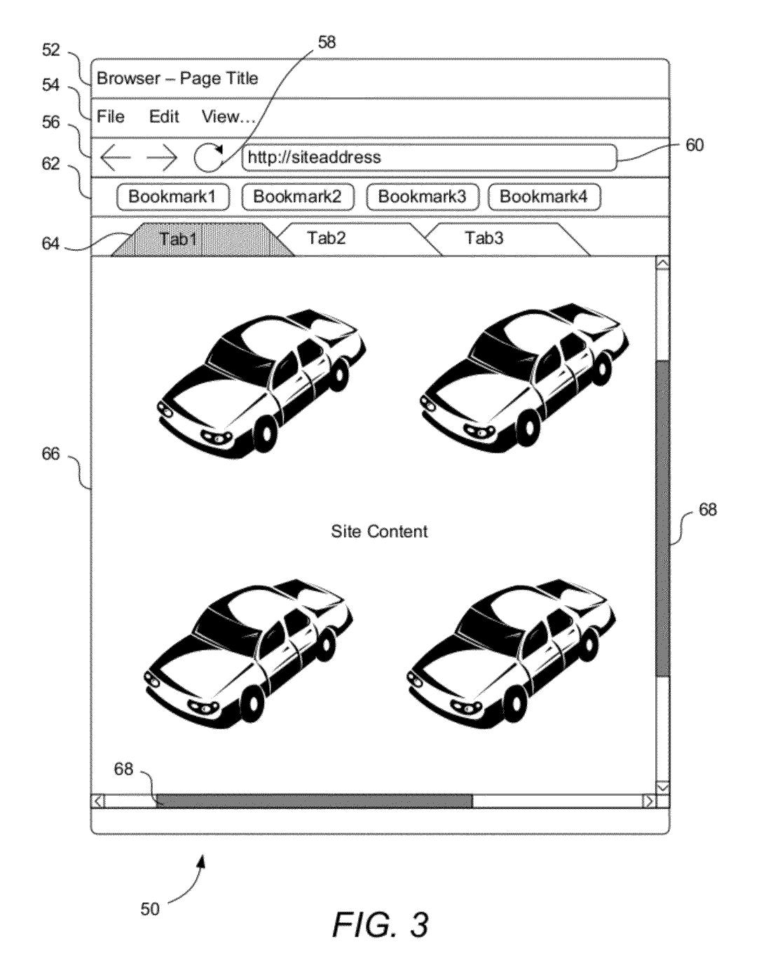

To minimize the need to download and/or install programs on users' computers, certain embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. While the exact display of each browser can vary from browser to browser and while most are moderately to highly configurable so as to vary the exact display, FIG. 3 shows a representative browser window 50 similar to what might be displayed on a user's computer device. It will be appreciated that many of the features described below with respect to the illustrated browser window 50 are optional or are optionally displayed or hidden as desired by the user, but each feature is typical or illustrative of features common to many browser programs.

The browser window 50 of FIG. 3 includes a title bar 52. The title bar 52 often is used to display a page name of whatever page is actively being viewed. Most commonly, the page name that is displayed is selected by the administrator of the website being viewed, and the page name often includes one or more phrases associated with the administrator of the website and/or the page being viewed. The browser window 50 also includes a menu bar 54 that includes items that may be selected to provide access to various menu functions, as is well known in the art. Of course, the menu functions provided in the menu bar 54 may vary according to the specific browser program, among other considerations, and access to menu functions may be provide other than by a menu bar similar to menu bar 54.

The browser window 50 of FIG. 3 also includes an address bar 56, which in the browser window 50 shown in FIG. 3 includes several browser controls 58 and an address entry area 60. The browser controls 58 and the address entry area 60 facilitate browsing using the window, permitting the user, for example, to go back one or more pages, to go forward one or more pages, to refresh a page, and/or to type in a destination site's address to directly access a page. Such browser features are well known in the art and need not be further discussed.

The browser window 50 also includes a bookmark bar 62 that a user can populate with bookmarks to commonly-accessed web pages, such that the user can quickly re-access the page(s) by clicking on the relevant bookmark button. In most common browser programs, it is possible for the user to have several different websites open simultaneously, and for the browser to provide rapid access, switching between, and management of the various open sites by way of various tabs 64, as shown in FIG. 3. Each tab 64 provides access to one open website. The tabs 64 facilitate navigation between different open websites. The contents of each open and actively-viewed website may be displayed in a content area 66. Thus, the content displayed in the content area 66 may vary depending on which tab 64 is selected, and which website is being viewed.

Whereas the tabs facilitate navigating between different websites, the browser window 50 optionally includes features to facilitate navigating within a website, as is known in the art. Specifically, the browser window may optionally include one or more scroll bars 68. When a portion of the website being viewed lies outside of the viewable portion of the content area 66, the user may use the scroll bars 68 to access non-visible portions, as is known in the art.

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality. For example, a stand-alone application may work in conjunction with the browser to provide functionality to the browser program. In some systems, smart phones and other mobile devices being examples, a program commonly called an app may provide specific functionality tailored to specific devices. Programs such as these may provide functionality discussed herein as being provided by a browser extension.

Embodiments of the invention utilize a browser extension or similar format to provide information sharing, and particularly session sharing between remote computers, so as to permit a browser program on one computer to “follow” a browser program on another computer. In this way, embodiments of the invention provide information sharing between computers at very low amounts of bandwidth, as will be discussed in more detail below. Additionally, the use and installation of a browser extension is typically significantly less involved and less computer-intensive than the use and installation of a stand-alone program of the type commonly used by providers of online collaboration software (e.g. GoToMeeting or WebEx). In many instances, the installation of the browser extension occurs essentially without the computer's operating system being made aware of any additional installation. Instead, the browser program itself handles the browser extension and any demands made by the browser extension.

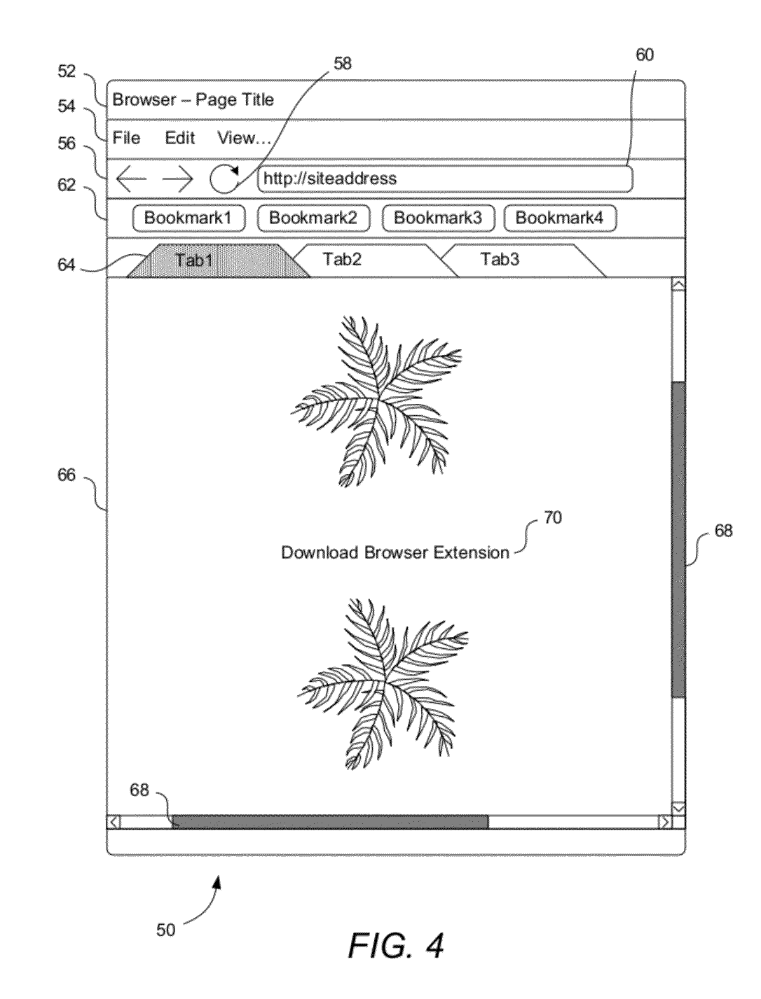

A browser extension in accordance with embodiments of the invention, for example, may be rapidly and easily installed, such as by visiting a download website. An example of such a website is shown in FIG. 4. A user desiring to obtain functionality associated with embodiments of the invention may visit a website such as that illustrated in FIG. 4, and may select an installation link 70. Upon selection of the installation link 70, the user may be prompted to confirm in one or more steps that he or she wishes to download and install the browser extension. If the user confirms that the browser extension is to be downloaded and installed, the download and installation is completed.

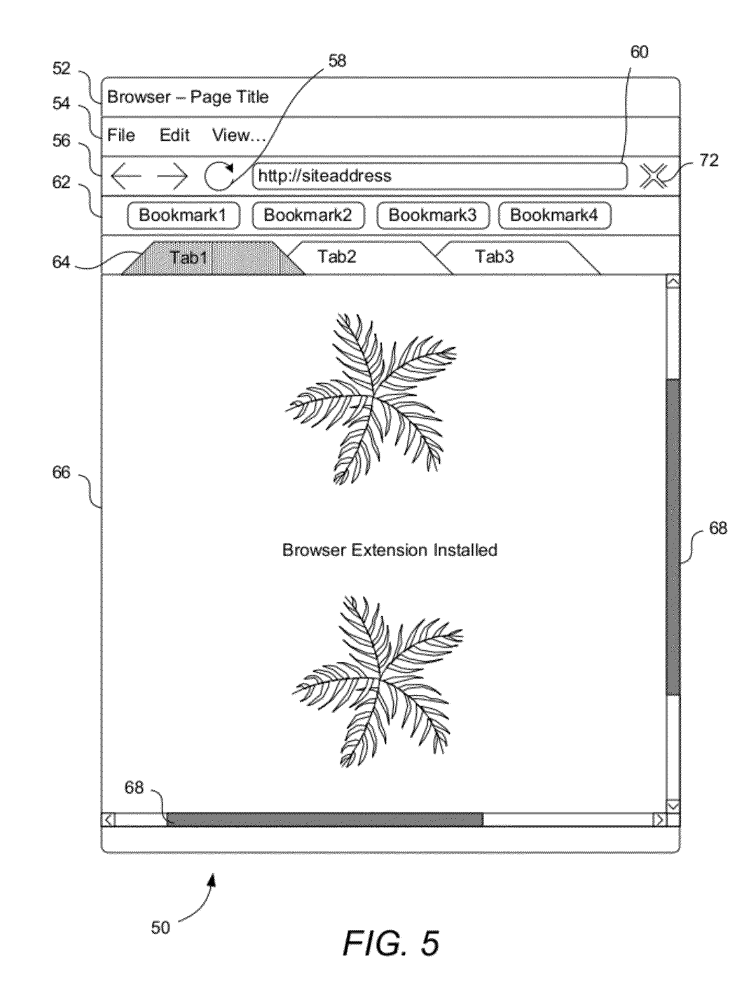

Access to the browser extension may be provided according to any method known in the art, but one example is shown in FIG. 5, in which it can be seen that a browser extension icon 72 has been added to the address bar 56. Of course, where an icon such as the browser extension icon 72 is provided, it may be provided at any desirable location or on any desirable toolbar within the browser window 50. Additionally, features provided by the browser extension may alternatively be accessed by one or more menu functions accessed through a browser menu or any other similar mechanism, as well as by any means or mechanism for accessing such functions now known in the art or later created, such as keystrokes, mouse inputs, touchscreen inputs, macros, and the like.

Once the browser extension has been installed (which is a relatively easy process as described above), the browser program and the browser extension may be used to allow one user's browser to follow another remote user's browser, with very minimal network traffic passing between the two users' computers and with many benefits over existing systems, some of which will be described below. While the specific functionality of the browser extension may be varied in essentially infinite ways while maintaining the functionality that will be discussed herein, including customizations for each user to facilitate each user's access, a description of ways in which that functionality may be provided is given below.

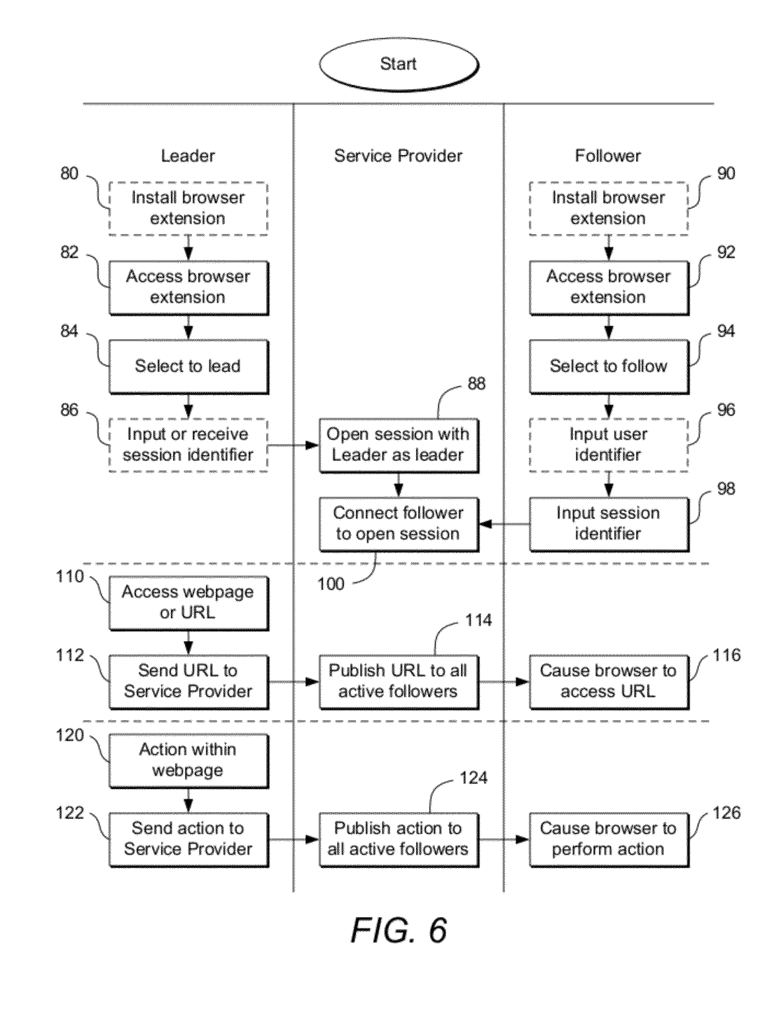

FIG. 6 conceptually illustrates how the browser extension may be used to permit one or more following users' browsers to “follow” a leading user's browser. In FIG. 6, the conceptual action may be broken down into actions at the leading user or “Leader” (left column), at the following user or “Follower” (right column), and at a service provider (center column). While FIG. 6 depicts actions occurring at or distributed across three “locations” (the Leader, the Service Provider, and the Follower) which need not be physical locations, it should be understood that some of the features and actions illustrated in FIG. 6 could be consolidated into fewer “locations” (e.g. at the Leader and the Follower only) or could be distributed to more than four “locations” as desired and appropriate. Additionally, actions illustrated in FIG. 6 may be conceptually provided into three phases. The first phase is a phase of establishing a leader-follower relationship between users. The second phase is a phase of “basic” following, in which the Follower's browser simply follows the Leader's browser between websites but takes no action at the websites. The third illustrated phase is a phase of more-advanced following, in which the Follower's browser may provide additional following functions.

In the phase of establishing a session (or any other type of leader-follower relationship between the Leader and the Follower), execution may proceed as illustrated in FIG. 6. On the side of the Leader, execution begins with the Leader installing the browser extension at step 80. Of course, this step may be optional, as the Leader may have installed the browser extension previously. The Leader then accesses the browser extension at step 82, such as by clicking on the browser extension icon 72 shown in FIG. 5. After the Leader accesses the browser extension, the Leader then selects an option to “lead” a leader-follower session at step 84. At step 86, the Leader either receives a unique identifier that will be associated with the session (e.g. from the service provider), or inputs a unique identifier associated with the Leader (for example, the Leader's e-mail address). This step may be optional if the system uses a user-input identifier such as the user's e-mail address and if the user has already input this identifier, or if the system uses some other user-unique identifier (e.g. a username, etc.).

In most instances, the Leader will not have multiple concurrent sessions active, although it is possible to do so, for example, if different browsers and different session identifiers are used. Alternatively, a browser extension may be provided that supports multiple different sessions within a single browser (e.g. one session per browser tab 64). Such embodiments may be particularly useful for purposes of customer support or computer support, for example. Regardless, as user-input identifiers such as user e-mail addresses are usually easily remembered by the owner of the e-mail addresses and are often commonly known by persons associated with the owner of the e-mail address, use of the Leader's e-mail address as the identifier is one easy way to readily permit creation of the session.

Once the Leader has either opted to lead a session at step 84 (having previously provided or received a session identifier) or has input or received a session identifier at step 86, the browser extension communicates with the service provider or causes the Leader's browser to communicate with the service provider to request a new session, and the service provider opens a new leader-follower session at step 88. As may be recognized, the total size of communication between the Leader and the service provider necessary to open a new leader-follower session may be very small, as the only information being passed is a request to open a new session and the identifier or any other session-identifying information.

On the side of the Follower, the steps are largely similar. Execution begins with installation of the browser extension (if not previously installed) at step 90. The Follower accesses the browser extension at step 92 and selects to follow a session at step 94. If the user has not previously identified himself or herself to the browser extension, he or she optionally does so at step 96, largely to permit the service provider to notify the Leader who is following the session. This step may be optional in certain situations, as it may be desirable to permit anonymous following in some circumstances. Alternatively, this step may be optional if the Follower has previously identified himself or herself to the browser extension.

While it may be optional for the Follower to identify himself or herself to the browser extension (and correspondingly to the service provider), it is necessary for the Follower to provide some sort of identification of the session to be followed. Thus, the Follower provides information identifying the proper session at step 98. In the illustrated flow of FIG. 6, this information is the session identifier, which is typically provided to the Follower by the Leader in any way desirable, such as by oral communication (including telephonic communications), e-mail, on a website, or by any other applicable communication, including by physical mail and the like. The information identifying the session to be followed is transmitted by the Follower's browser extension to the service provider or the browser extension causes the browser to transmit the information to the service provider. As will be appreciated, the size of such communication is again quite small. The service provider then connects the follower to the identified session at step 100.

The manner of establishing a session shown in FIG. 6 is not the only possible way to establish a session. As one alternative to establishing a session in the manner illustrated in FIG. 6, the session may be established by way of one or more invitations between the Leader and any Followers to be part of the session. Such invitations may be transmitted by any known mechanisms, but may automatically join to the invited Followers to the session without requiring that the Follower input any session identifier. If the Follower already has the browser extension installed, a link in an e-mail communication may automatically activate the browser extension of the Follower and connect it to the session. Alternatively, if the Follower already has the browser extension installed and active (e.g. the browser is running), the invitation may be received by the browser extension and a notification of the invitation provided by the browser extension. The Follower could then click on a button or link to accept the invitation and be joined to the session. Any other manner of joining the Follower to the session could also be used.

Unlike with current web conferencing systems, the establishing of a session and connecting followers to the session need not involve sending massive amounts of information regarding what is displayed on the Leader's monitor or other viewing screen to each connected follower. Additionally, the establishing of a session and connecting followers to the session does not require reformatting or resizing either of the Leader's display or any of the followers' displays. If any initial information is sent, it may be limited to simply forwarding a URL of the website to which the Leader's browser is currently pointed to all followers as they connect to the session. Alternatively, it may be limited to forwarding a URL of the website to which the Leader's browser is currently pointed plus any additional information conveyed to provide additional following functions (e.g. location within the displayed webpage to move to, location of the Leader's pointing device within the page, etc.), as will be discussed in more detail below. As another alternative, no initial information is sent to each follower after connecting the follower to the session until the first time an action to be followed occurs in the Leader's browser after connection of that particular follower. Regardless, if any initial information is sent to the Follower after the Follower is connected to the session, the amount of information is relatively minimal, as will become apparent from the discussion regarding following below.

It should be noted that the steps in the initial phase of establishing a session and connecting one or more followers to the session as discussed above may occur essentially simultaneously or they may be separated in time by any desired amount. The only constraint is that a session must be open at the service provider (or, if the features discussed above are provided by a stand-alone system at the Leader's computer system, a session must be open at the Leader's computer system) before one or more followers joins the session. If a follower attempts to access a session that has not yet been opened, the service provider simply provides notification that no session corresponding to the entered session identifying information currently exists, and the follower waits for a period of time before reattempting to connect to the session. Alternatively, the browser extension may allow the follower to opt to join the session when it becomes available and automatically connects the follower to the session when it becomes available. The time differential between initiation of the session and joining of one or more followers to the session may permit one or more prospective followers to join sessions in progress at essentially any time during the sessions. Alternatively, a session may not be a live session, but may be a recorded session, as discussed in more detail below, and a request to access the session subsequent to recording the session may permit later playback of the recorded session.

Once the Follower is connected to the session at step 100 and any desired initial information is sent to the Follower, execution can then proceed to the second phase and/or the third phase illustrated in FIG. 6, namely “basic” following and/or following provided with additional features and information. For the “basic” following features, the Follower's browser is simply caused to access any websites and/or pages accessed by the Leader, in near-real-time and as the Leader accesses them with the Leader's browser. Thus, execution begins at step 110, when the Leader directs his or her browser to access a webpage or URL by any means commonly known in the art. For example, the Leader may type a URL into the address entry area 60, may select one of the Leader's bookmark buttons displayed on his or her bookmark bar 62, may select a link within a webpage currently displayed in the Leader's content area 66, may select one of the browser controls 58, may select a link from a different program intended to direct the Leader's browser to a URL, or may take any other action intended to cause his or her browser window 50 to display or access a webpage accessible by the browser program.

It may be appreciated that the actions taken by the Leader to cause the browser program to access content may be tailored to fit the needs of the particular leader-follower relationship. For example, if the leader-follower relationship is one established between individuals associated with a common business and having access to similar information available on a local network, including content that may be protected from access by outside individuals, the Leader may even choose to access local content which may include protected content. In contrast, if the leader-follower relationship is one established between otherwise unassociated individuals, the Leader may choose to limit his or her access attempts to publicly-available content such as content freely available on the Internet. In such a situation, if protected content will be accessed, further action may be necessary, as will be discussed below.

Regardless, when the Leader directs his or her browser to access the website or other content, the uniform resource locator (URL) or other identifying information (e.g. uniform resource identifier (URI), Internet Protocol (IP) address, etc.) is sent by the browser extension or is caused to be sent by the browser extension through the browser to the service provider at step 112. As will be readily appreciated, the total amount of information thus sent to the service provider may be orders of magnitude smaller than the information that is sent by existing systems that rely on streaming of information. For example, the total amount of information may be no more than is normally sent by the browser program on making a request to access a particular webpage.

The service provider receives the identifying information (e.g. URL) and publishes the information to all active followers at step 114. (Alternatively, the identifying information may be sent directly from the Leader's system to any followers without involving a service provider.) Again, the total amount of information sent to the followers is significantly smaller than the amount of information sent by services relying on streaming. Thus, the total number of followers that may be connected to a session may be essentially limitless with comparatively little additional demand placed on the service provider. Scaling up the number of followers may be accomplished without requiring the service provider to assign significantly greater resources to the session. Overall network traffic through the service provider is therefore kept quite low.

The Follower receives the published identifying information (e.g. URL) at step 116, and the Follower's browser extension causes the Follower's browser window 50 to “follow” the Leader's browser window 50, thus directing the Follower's browser window 50 to the same location. The effect is that of being in communication with the Leader (e.g. by telephone) and having the Leader say “Go to such and such a website,” but without requiring the Follower to take any action to get to the website. The Follower's browser accesses the desired website as per any normal browsing session, downloading content directly from the accessed website at whatever connection speed available to the Follower. Similarly, the Leader's browser accesses the desired website as per any normal browsing session, downloading content directly from the accessed website at whatever connection speed available to the Leader. Such download occurs on both ends without any download information necessarily passing through the service provider or through the session connection.

The Follower then is able to “see” the same site viewed by the Leader, but with any preferences desired by the Follower. For example, the Follower may have a screen with a different resolution and may have his or her browser window 50 sized differently from the browser window 50 of the Leader. Additionally, rather than have his or her system taken over by an intensive streaming session, each user (the Leader and every Follower) can dedicate as much of his or her computer resources and screen space to the browser window 50 as desired, and can have other computer resources, including other browser windows and other programs, open and active and/or directed to other resources. Thus, embodiments of the invention provide great flexibility in sharing information and a browser session between computers without stressing connection resources between the computers with which information is shared.

Either the leader or any of the followers can stop or exit the relationship at any time. Thus, the browser extension may provide a “stop” button or the like to permit exiting of the relationship. Alternatively, the user may simply shut down the browser through which the relationship is provided and with which the browser extension is associated. If a follower exits the leader-follower relationship, then the session may remain active with the leader and any remaining followers as part of the session. If a leader exits the leader-follower relationship, the most typical behavior may be to terminate the session. Alternatively, the session may remain active, at least for a period of time, in case the leader unintentionally left the relationship and desires to return into the relationship. As an additional alternative, a hierarchy of leadership may be established whereby when one leader leaves, a new leader is automatically established for the group. As still another example, one leader could choose another leader before leaving, and thereby become a follower before leaving. Other possible behaviors could be provided, and the foregoing are simply examples of possible behaviors.

While “basic” following as discussed above is a powerful tool available to connect leaders and followers, it may be expanded in various ways. One way of course is to add one-way or two-way vocal communication between the various users. The vocal communication may be provided by any means or mechanism known in the art, including by way of existing telephone communication as commonly occurs today with many online collaboration tools, with audio communications systems and tools provided by online providers (e.g. Skype and the like), or by way of passing audio communications through the service provider in conjunction with the browser extension. It will be appreciated that the passing of audio communications through the service provider may increase the bandwidth to be handled by the service provider, but when compared with the bandwidth necessary with existing streaming-based collaborations services, the resource savings are still appreciable. Different versions of the browser extension may provide or not provide audio versions or capabilities, as applicable to each particular embodiment of the invention.

As may be appreciated, one-way audio communications may be sufficient and desirable in certain situations, such as a lecture or seminar type of situation. In such situations, it may not be necessary for followers to communicate audibly with leaders. In other situations, two-way communication may be desirable. Thus, in certain embodiments of the invention, one-way audio information may be provided, while in other embodiments two-way audio or even no audio may be provided. The audio needs of each situation may be assessed and addressed accordingly, and the provision of audio communication or its equivalent may be coupled to or decoupled from the other functions as desired.

Either one-way or two-way audio communications may enhance following in various ways. For example, the leader may communicate information about the websites being visited or may incorporate the websites being visited into a lecture or presentation. Alternatively or additionally, the leader may communicate directions to one or more followers about the websites being visited, such as to instruct followers to scroll down or over to a particular location on a website, or to otherwise interact with a website. As an example, the leader might visit a website with content protected by a password or a username and password combination and might convey information to the followers allowing access to the protected content.

There are other ways that may be used to enhance “basic” following of the type described above. For example, it may be desirable for a leader to be able to use his or her cursor to point to specific areas of a desired website. Alternatively or additionally, it may be desirable for a leader to actively move followers' displays of the website to a specific location within the website. Again alternatively or additionally, it may be desirable to interact with the visited websites on the various followers' browsers as well as on the leader's browser. Therefore, embodiments of the invention embrace the provision of any such features.

For example, the browser extension on the leader's computer could optionally track the location of the leader's pointer whenever it is within either the browser window 50 itself or when it is at least within the content area 66, and this information could be conveyed through the service provider to any followers. The browser extension at the followers' computers could then generate and display a representation of the leader's pointer within the followers' browser window 50 or content area 66. Additionally or alternatively, the browser extension on the leader's computer could track what portion of a visited website is currently displayed in the leader's content area 66 and/or could track what portion of the visited website is currently displayed in the leader's content area 66 and whether the leader's pointer is located anywhere within the portion displayed and could convey this information through the service provider to any followers. The browser extension at the followers' computers could then optionally move the portion of the visited website displayed in the followers' content area 66 to best approximate the portion being viewed at the leader's browser window 50. If such action is possible, the browser extension might provide options to allow the followers to either override such changes or to opt out of receiving such changes.

The foregoing is only one example of a way of sharing the leader's particular view with the followers. Another possibility for sharing the leader's particular view involves the use of intermittent screen captures, either of the leader's browser window 50, or of the entirety of the leader's visible screen area (e.g. desktop). Certain methods of sharing the leader's view by way of screen capture may differ significantly from existing online collaborative methods relying on streaming services. For example, instead of streaming the screen captures directly through the service provider to the various followers, with the associated necessary bandwidth increase, the screen captures are instead automatically uploaded to a website with each uploaded screen capture having a distinct URL, the URL for each screen capture is then forwarded through the service provider to the followers, and the followers' browser extension then directs the followers' browser to the screen captures in turn.

Intermittent screen captures in accordance with such methods may occur on any desirable schedule, from fractions of a second to minutes or longer, depending on the anticipated or desired time resolution to be provided to the followers. In at least some instances, the timing may be varied within a presentation, such as by being selectively varied according to a rate of change of display occurring and detected at the leader's computer. As may be appreciated, providing screen captures in this fashion may very nearly mimic the streaming experience currently provided by online collaboration tools. Additionally, as mentioned above, screen captures may be used to provide information extending beyond the leader's browser.

To permit sufficient time for upload of any screen captures and creation of any necessary webpages and URLs to permit the followers to access the screen captures and retrieve them by download, a time lag or time shift may be incorporated into the presentation. While a time lag or time shift may not be desirable in all circumstances, and may in fact hinder two-way communications types and collaborations within a session, the advantages that may be obtained in certain situations may make it desirable. If desired, the time shift or time lag may be further extended to allow the browser extension time to cause the followers' browsers to pre-download a portion of the screen captures in advance so that the followers' user experience mimics the experience intended by the leader.

As discussed above, it may be desirable at times to have the followers' browsers interact with interactive websites. Therefore, another potential enhancement of simple following would be to have the various followers' browser extension cause interactions with interactive websites similar to interactions occurring at the leader's browser window 50. For example, if the leader opts to play an embedded video or animation on a visited website, the browser extension at each of the followers' computers might initiate playing of the video or animation as well. As another example, if the leader inputs a password at a password-protected site, the password might simultaneously be input at the site via the various follower browsers. In this way, the leader might not need to orally or otherwise convey password information, and the password information might even remain secret even though it was locally entered at all of the followers' computers.

To facilitate entry of password information for followers, the browser extension might incorporate password management and input technology similar to existing technology provided by a variety of providers with certain modifications. One example of existing password management technology is software currently being provided as LastPass (currently available at lastpass.com). Existing password management software may be installed as a browser extension and saves users' password information for automatic entry into password-protected sites. The existing password-management software is typically computer and/or user-specific such that the users' passwords are protected against loss. If a browser extension according to embodiments of the invention utilizes password entry technology, it may function differently in that it permits single-use sharing of passwords with multiple followers without permanently providing the password to the followers.

Thus, the leader's browser extension conveys the password information through the service provider to the followers' browser extension, which uses the password information for one-time, limited-time, or free use input into the applicable website. The leader can select in advance or in real time whether to share a password and to what extent the password may be used by the followers (whether just once, for a limited time, or indefinitely). The followers' browser extension keeps and uses the password information only for any applicable permitted time or use. As may be readily appreciated, any transmitted password information may be encrypted during transmission as well as during storage on the followers' computer(s).

FIG. 6 illustrates actions that might occur with many of these enhancements and/or features. For example, at step 120 an action within a website is received or noted at the Leader's browser. The action might be any action of the type discussed above, or any other action that might be useful with embodiments of the invention. The browser extension interprets the action and sends information about the action to the service provider at step 122. At step 124, the service provider publishes the action to all active followers, and at step 126 the Follower's browser extension causes a corresponding action (which may or may not be an identical action) to occur within the Follower's browser. Because the display on each of the followers' browsers may be slightly to significantly different (from the display at other followers and from the Leader's display) and because each follower may have different settings including settings regarding whether or not to accept certain actions, the response (if any) at each follower's browser can vary significantly.

The foregoing examples of additional features and enhancements of following are merely to be taken as illustrative of possible additional features and enhancements, and are not intended to be an exhaustive list of all possible features and enhancements. There are potentially many other examples of possible additional features and enhancements. One possibility includes the provision of one-way and two-way textual communications between the leader and followers in addition to or as an alternative to audio communications. As the necessary bandwidth for textual communications is often significantly lower than the bandwidth required for audio communications, use of such communications may be helpful in situations where only limited bandwidth is available. If desired, one or more of the systems may provide speech-to-text and/or text-to-speech capabilities where audio is not directly available between systems, such as due to bandwidth limitations.

Another possible enhancement or feature may be related to any content filtering that may occur as the various users visit websites. For example, one or more followers may have chosen to filter certain types of content or may have filters of certain types of content imposed upon them by a workplace policy. If such filters are encountered, certain embodiments of the invention may detect the occurrence of such filtering and may convey to the leader that filtering has occurred to permit the leader to alter the presentation or include/visit alternative websites to compensate for the filtering. Alternatively, upon notification of content filtering, the leader may utilize screen capture features as discussed above as an alternative method to provide access to content-limited followers.

While the bandwidth necessary for necessary and even enhanced communications between the leader and the various followers is typically quite small, the fact remains that each individual browser still needs to access content from the various websites' originating servers. It is anticipated that at least some followers may have bandwidth constraints that could potentially impact the followers' user experience such as by failing to load a website before the leader has moved on to an additional website. Various potential enhancements could be provided to address such situations. For example, the followers' browser extensions could monitor loading and could convey loading information back to the leader to permit the leader to appropriately pace website changes and/or his or her presentation. As an alternative, the system could automatically slow the presentation down to a speed allowing the follower having the lowest bandwidth to load the appropriate pages. Alternatively, the system could slow the presentation down, but only to a speed satisfying a certain percentage of the followers. As still another option, some form of time shifting may be provided to at least some followers to provide them with the best experience. Other possibilities exist and are embraced by the various embodiments of the invention.

Time shifting could be used to provide other functions and features to embodiments of the invention. For example time shifting could be combined with filtering and changing functions to allow a leader to undo an event. If, for example, a leader was conducting a session and arrived at an undesired website (such as one containing content not appropriate for certain of the followers like pornography, or simply any website not intended to be part of the session), the leader might want to edit out or remove the visited website from the session. In instances where the session occurs in real time or near-real-time, it might be difficult to prevent followers from arriving at the undesired content as well, other than by detecting potentially-objectionable content in advance and providing the leader with a warning about the content. With time shifting, however, the leader might be provided with an option to undo the visit to the undesired website and to continue the session without the undesired visit. Alternatively, if the leader happens to have control over the content of the website being visited, the leader could potentially even change the content of the website before it is visited by the followers, such that the experience of the followers differs from the experience of the leader. The foregoing are merely some examples of functionality that may be provided in association with time shifting functions to provide some desired filtering of the content of the session.

One advantage of embodiments of the invention is it utilizes existing browser technology to provide access to various existing websites to the followers. An associated advantage of this use of existing browser technology is that most browsers maintain a history of websites visited, inherently allowing users of the technology to go back and visit the websites visited during a meeting or collaboration at a later time such as for further study, a refresher of what was visited, or to view updates of interesting websites. One weakness of existing online collaboration tools is the lack of any kind of history of what was presented using such tools. While the inherent provision of a history through the various user's browsers is beneficial, a further enhancement that may be provided by some embodiments of the invention is the provision of an ability to contain a history within the browser extension.

Such a history may be more feature-rich than a normal browser's history in several fashions. For example, it may be separately maintained and may be maintained for a period of time independent of the browser's normal history retention. Additionally, the browser extension history may maintain an order of websites visited, allowing the user to essentially play back the presentation. If there are textual or audio components associated with a presentation, such components may optionally be saved to permit full playback of the presentation at a later date. The provision of such a history may be permitted on the leader side, so a leader could optionally essentially record a presentation (whether or not any followers were actively following the initial recording of the presentation) for later playback to followers or to a different group of followers. Presentations of this type could be uploaded to the service provider for later access by followers as desired. A leader could arrange or record a presentation simply by assembling a series of bookmarks into a presentation with appropriate timing for moving from bookmark to bookmark, and would not necessarily need to record a presentation in real time.

In truly collaborative situations, it may be desirable for a person that is following a leader to become the leader of the group so as to permit that person to direct the group to desirable websites. Certain embodiments of the invention therefore allow a leader of the group to pass leadership to one of the existing followers. Alternatively, a follower might be allowed to request leadership of the group through the browser extension, and the then-current leader could accept the request, thereby passing leadership to the follower. In either instance, the browser extension of the follower who becomes the leader would change modes to receive the new leader's actions in a fashion similar to that discussed above, according to whatever leader-follower functions are available in the particular embodiment. A leadership change may be desirable in any one of a variety of situations, such as for a presentation where remote co-presenters are presenting portions of a presentation, or for a situation where an original leader encounters an emergency and has to pass leadership to another person to continue a presentation.

When leadership changes in this or any fashion, a response of the system to new follow requests might be varied. For example, the system or service provider could be configured to maintain the original session identifier, thereby allowing any new follow requests to be connected to the originally-intended session. Alternatively, the session identifier could be changed to reflect the new leadership. If a change of this type occurs, the system may notify new follow requests that a change has occurred to a previously-existing session and may provide users with the option to join the session under the new leadership.

Consider, for example, a situation where a leadership change occurs and where a previous leader, now a follower, opts to exit a session. If the previous leader then decides to begin a new session, requests to follow the previous leader that are based, for example, on the previous leader's identifying information (e.g. e-mail address) could potentially be directed to the second session when the followers' intention was to be a part of the earlier session still underway but under new leadership. The system could be configured to recognize such situations and provide users with an option to follow either of the available sessions.

Another example of features and enhancements that may be provided by certain embodiments of the invention is an ability to have nested following, or following of followers. Such following of followers could mimic or provide social networking features. Embodiments of the invention could allow followers to either prohibit or allow others to follow them as they in turn follow other users. If they permit others to follow them, then chains of following could be arranged with varying levels of interaction.

For example, as the second phase of FIG. 6 (discussed above) shows, in certain embodiments, the various browser extensions may only be active when a leader opts to access a website or URL, and the URL is then published to any followers. Thus, in at least some embodiments, after a follower's browser has been updated to display the website being accessed by the leader, the follower could opt to leave the website being accessed by the leader, even if the leader is still accessing or viewing the original website. For example, the follower might be bored by the website selected by the leader and might want to visit a different website until a more interesting website is accessed by the leader.

The follower could view any of a number of websites before the leader chooses to access a different website, whereupon the follower's browsing would be interrupted as his or her browser was automatically redirected so as to follow the leader's selection of a new website. The follower could then choose to stay with the leader for any length of time or could again opt to browse other websites. In embodiments where followers are permitted to follow followers, the followers following the followers would receive the website changes from the chain of users above them and could then choose to vary their browsing as well, leading to interesting interactions among users.

For example, a base leader might be a celebrity national television host providing an interactive web experience linked to his or her national television show. As the television host discusses newsworthy information that the host located on a website, he or she could use his or her browser to visit the website, and the browsers of any followers of the television host would automatically visit the same website. Local commentators or local television providers could be among the followers of the television host, and could have local individuals following them. The local commentators or local television providers in each market could have different insights, comments, or websites that they want to bring to the attention of their local viewers, and they could, for example, “leave” the website being viewed by the national television host to visit an additional website of local interest. Alternatively or additionally, they could provide textual information as discussed above to expand on, refute, or otherwise comment on the information provided by the national television host. Thus, the associated web browsing experience in each locality could be individually and locally customized in real time for the local followers who are each following a local commentator or local television provider who is in turn following the national television host.

The foregoing examples are simply examples of possible features that could be incorporated into versions and embodiments of the invention. Not every feature need be incorporated or available in every version and embodiment of the invention. Additionally, it should be apparent that other features other than those specifically discussed above may be made available with certain embodiments of the invention and still fall within the scope and embrace of implementation of the invention.

Embodiments of the invention provide many advantages over existing systems and methods. One benefit of embodiments of the invention is near-universal availability of the leader-follower relationship. The browser extension is a minimal installation load and may therefore be readily installed on nearly any computer device having a browser, including even very slow computers that would be severely hampered or slowed by installation of the large custom programs used by today's online collaboration providers as well as computer systems having limited bandwidth compared to what is needed for today's systems relying on streaming. Thus, there are essentially no limits on the type of computer device that may be used with embodiments of the invention to provide a leader-follower relationship.

An additional benefit is the scalability of the leader-follower relationship. To scale a system used by existing collaboration systems that rely on streaming between computers requires adding significant amounts of additional server capacity, which is why most providers of such services typically use a scaled pricing structure that will account for the additional hardware needs associated with larger numbers of participants. In contrast, the additional computing resources and bandwidth necessary to add followers to a leader-follower relationship or session is comparatively minimal, resulting in significant cost savings. Most of the network traffic generated by the leader-follower relationship is not directed between the leader and follower computers or between the leader or follower computers and the service provider systems, but is instead directed between the leader and follower computers to existing websites provided by other entities (as well as the redundant servers of the Internet) that are designed to handle such traffic.

Other benefits of embodiments of the invention will become readily apparent through use of the embodiments of the invention as well as through the discussion herein. Embodiments of the invention may be utilized for a variety of applications of varying complexity. For example, embodiments of the invention may be readily used between friends or by computer support personnel to direct users to a particular website. Thus, instead of getting someone on the phone and having a conversation along the lines of “Is your browser open? OK, type in ‘www.goto this horrible URL’ and press enter. It didn't work? Are you sure you typed it right?” etc., a leader-follower relationship is established and the leader just goes to the desired website and the follower arrives there as well.

As another potential application, a presenter could use embodiments of the invention to make a presentation such as at a conference or training. The presentation could be in person or remotely, but rather than the current situation where on each change of slides each user must look up at the presentation screen, with embodiments of the invention each page can be streamed to each participant's device. In some embodiments, the presenter would only have to ensure that each slide is converted to an individual web page, but programs could be readily provided to effect the conversion.

As another example of a potential application, live blogging, podcasts and microblogging could be enhanced in a fashion similar to that discussed above with respect to the television host. Followers could watch what their favorite celebrities are browsing in real time. Television shows could become enhanced with follow-along web presentations accessed in real time or near-real-time in conjunction with the shows. Radio programs, which normally are limited to audio only, could be enhanced with additional content online that is automatically accessed by followers' browsers in real time or near-real-time. These are merely examples of applications of embodiments of the invention, and it should be understood that many other applications of embodiments of the invention may be provided.

In certain embodiments of the invention, various types of information regarding participants in the leader-follower relationship may be provided. For example, either or both of the leader and any followers may be provided with information regarding the total number of participants in the leader-follower relationship. Additionally or alternatively, either or both of the leader and any followers may be provided with information identifying any participants (e.g. e-mail addresses or other identifying information provided to the various browser extensions). These are basic examples of information that can be shared about the participants in a leader-follower relationship. Other information could be shared or made available as desired.

It should be recognized that embodiments of the invention may include an optional password or other authorization step to ensure that only authorized followers are permitted to enter the leader-follower relationship. Thus, a user entering a follow request could be presented with a challenge to enter a password associated with the request. If the password is properly entered, the follow request would be granted. If not, the user could be prompted to reenter the correct password or the follow request could be denied. It should be recognized that embodiments of the invention may include an optional password or other authorization step to ensure that only authorized followers are permitted to enter the leader-follower relationship. Thus, a user entering a follow request could be presented with a challenge to enter a password associated with the request. If the password is properly entered, the follow request would be granted. If not, the user could be prompted to reenter the correct password or the follow request could be denied.

Embodiments of the invention may be incorporated into any of a variety of existing communication applications. For example, embodiments of the invention may be incorporated with and may provide features to existing audio or audio-visual communications application such as voice over internet protocol (VoIP) provider programs. Additionally, embodiments of the invention may be incorporated into online photo sharing entities and software, into social networking sites, into online presentation sites, into search engines, and may be provided through existing app marketplaces. For example, incorporation of the following functionality in a photo sharing site may allow someone who has posted photos to an album to use following to share the album in an interactive way with family and friends (such as while explaining the photos over the phone). The net effect could be that of mimicking the experience of two users sitting next to each other and flipping through a photo album together while talking about it. Thus, maximum flexibility of implementation of the embodiments of the invention may be provided for any of a variety of uses.

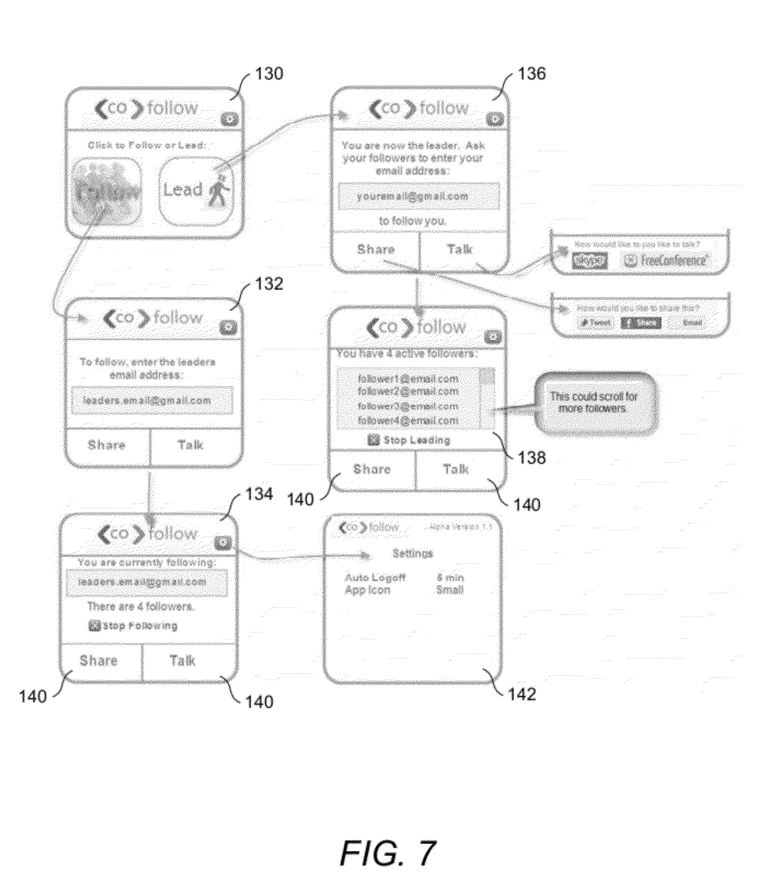

While many features, advantages, and embodiments of the invention have been discussed above, FIG. 7 illustrates an illustrative series of depictions of what might be displayed to a user in accordance with embodiments of the invention. Thus, if the user were to click on or otherwise select the browser extension icon 72 shown in FIG. 5, a small initial display 130 may be displayed to the user to allow the user to select whether to follow an existing session or lead a new session. If the user selects to follow an existing session, the display might change to a select session to follow display 132, permitting the user to input information identifying the session to be followed. When the proper information has been input by the user (along with any needed password(s)), the display might change to a currently following display 134, which might be displayed throughout the session or might be automatically or selectively hidden after a period of time. If, in contrast, the user opted to lead a new session, the display might change to a prompt followers display 136 to instruct the new leader as to what potential followers should do to follow the new session. Alternatively, the leader may be prompted to enter users to be invited to follow the new session. As followers begin to follow the session, the display might change to a currently followed by display 138 showing how many followers of the session there are and/or information about each of the followers.

If any additional features are provided, such as features to share or advertise a session on social media sites and the like, or features to enhance communication such as by providing audio or textual communications with the session or between one or more participants in the session, one or more buttons 140 or other feature-accessing mechanisms may be provided to either the leader or the follower(s) or both through the display to access the additional features. Additionally and if desired, a settings display 142 may be accessible and provided where necessary and to permit control of features of the particular embodiment of the browser extension.

While much of the foregoing discussion has incorporated the use of a browser extension as an example, it should be understood that the use of a browser extension was an example only, and not by way of limitation. Similar functionality may be provided by various applications and apps on different platforms. For example, such functionality may be directly incorporated into a browser program instead of as a browser extension. On a mobile device such as a smart phone or tablet computer, such functionality may be provided as an app that may operate separately from or in conjunction with any browser installed on the smart phone. The functionality may be provided by a separate application on essentially any computer system as well as any device providing a browser or browsing capabilities similar to a browser program. For example, browser programs are now being provided on some televisions and other electronic devices that have not traditionally had browsing capabilities. Other devices may be specifically designed primarily as browsing devices and may not provide many other common computer functions. Regardless of how the functionality is provided on each particular system or device, similar functionality may be provided. In this way, embodiments of the invention may provide communications across platforms in ways not possible with other systems and without requiring a major installation on such systems. Additionally, essentially the same interface may be provided on any device, making using embodiments of the invention on various devices a seamless and easy transition.

Embodiments of the invention may be used for any type of leading and following relationship in addition to those discussed above. For example, embodiments of the invention may permit a joint blogging experience or a joint shopping experience. Embodiments of the invention may provide joint media consumption experiences in a variety of fashions. For example, embodiments of the invention may allow users to follow a leader's media consumption and may synchronize the media consumption across various devices. Thus, for example, multiple devices may act as linked multiple-source outputs for playback of media such as music, videos, and the like.

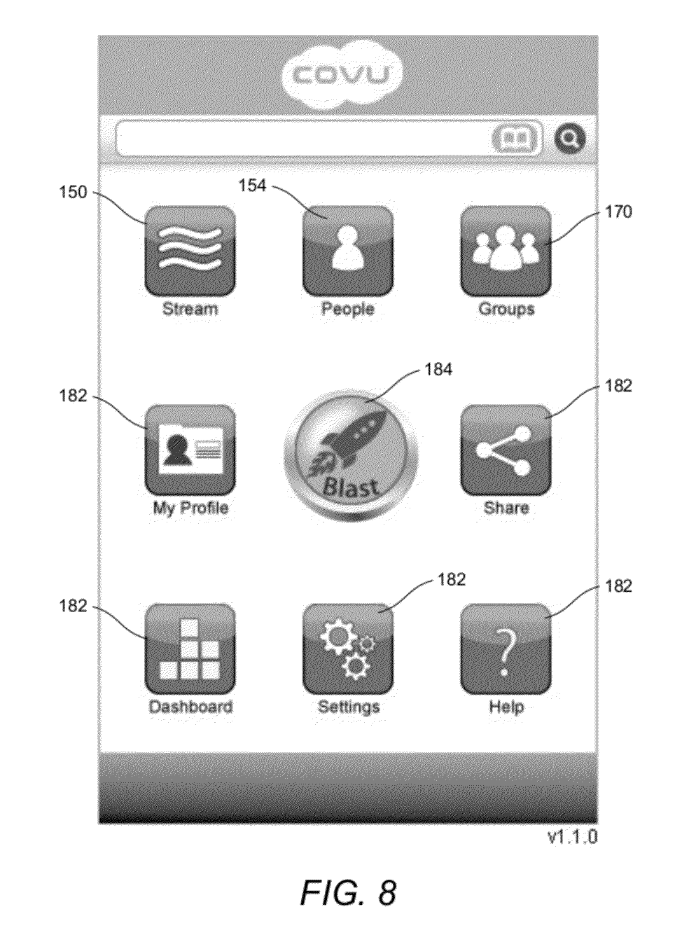

Embodiments of the invention may allow leaders to provide any of a variety of information types to followers, and such embodiments are not limited to permitting following of live or time-shifted following as described above. For example, embodiments of the invention may permit targeted message sharing, including any information that might be shared in an e-mail, text message, multimedia message service message, etc. FIGS. 8-15 show representative screen shots of an embodiment of the invention as it may be implemented on any of a variety of devices, depicting additional features of certain embodiments of the invention.

The depictions of any of FIGS. 8-15 may be displayed at appropriate times during use of the invention. For example, the depictions of FIGS. 8-15 may be selectively displayed upon selection of the browser extension icon 72 as discussed above. Alternatively, the depictions of FIGS. 8-15 might be displayed upon activation of an app on a smart phone or other portable device, and might essentially fill the screen of such a device. It should be understood that the exact display of FIGS. 8-15 is intended to be representational, and is not limiting in the information that might be displayed, the aspect ratio to be displayed, or in any other regard.

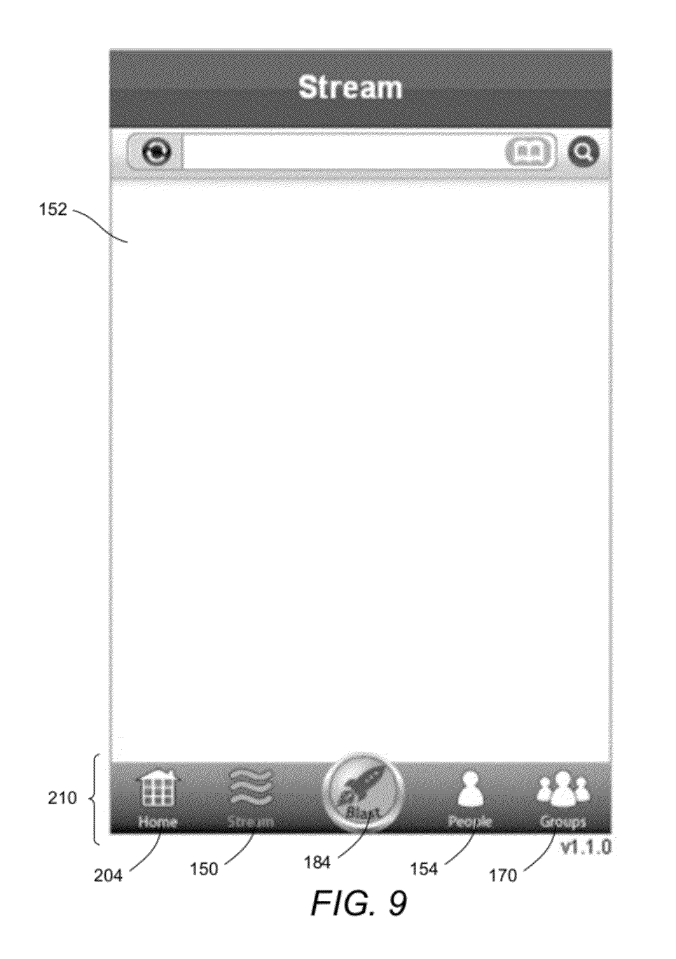

FIG. 8 displays a home screen that might be displayed to a user at appropriate times, after the user has registered to use the system and/or has logged into the system. Thus, FIG. 8 provides a representative home screen with icons providing access to various features of the system. For example, a stream icon 150 may provide access to a display such as shown in FIG. 9. The stream display of FIG. 9 may provide access to any recent messages or notifications relevant to the user, including the types of messages discussed herein. Without limitation, such messages may include text messages, messages with media (e.g. pictures, video, audio, documents, etc.) attached, invitations to join a live session, invitations to view a recorded session, messages with bookmarks to certain URLs attached, and the like. The information relevant to the user may be limited to incoming information or outgoing information, or may include both incoming and outgoing information. Any relevant information may be displayed in a content area 152 shown blank in FIG. 9.

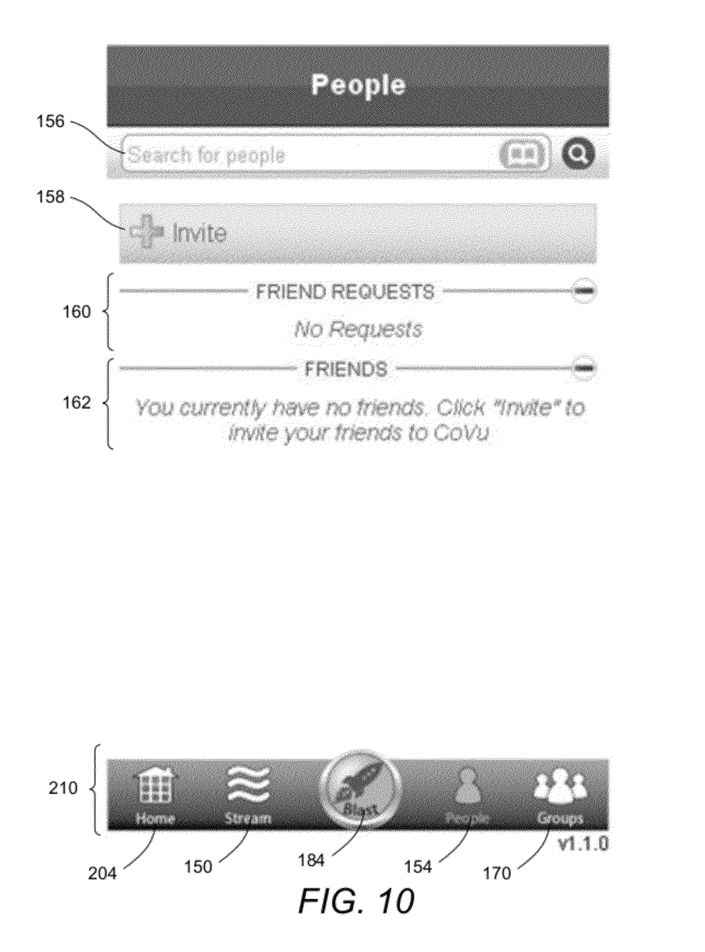

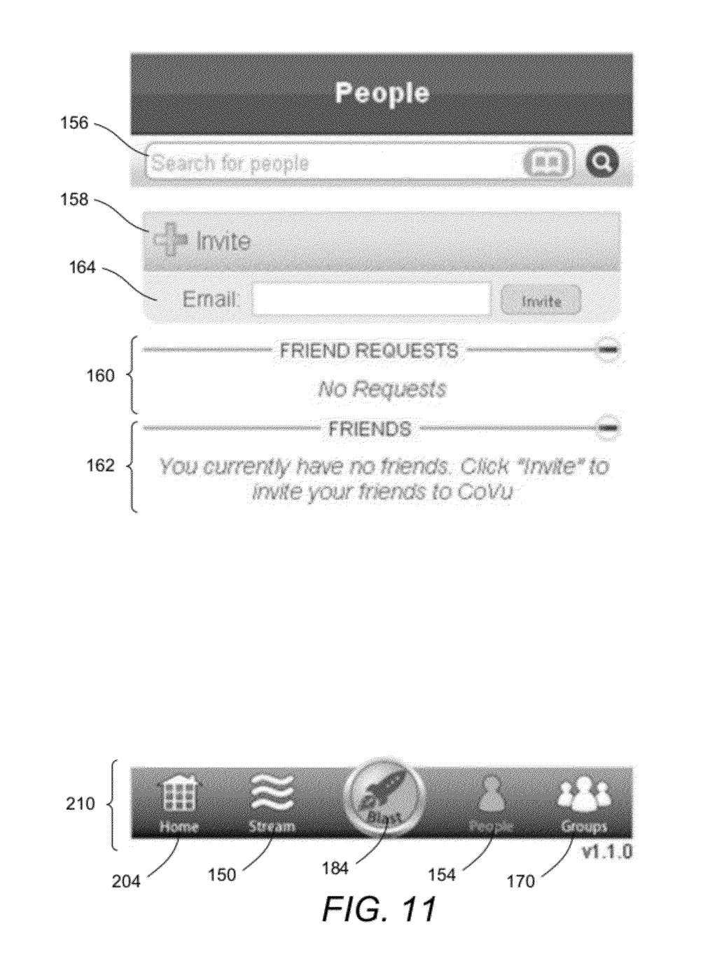

Returning to FIG. 8, a people icon 154 may provide access to a screen display such as shown in FIG. 10. To become a leader or follower, the user will become a leader or follower of other people or another person, unless a session or other information is to be prepared for later consumption, and even then the session or other information is intended to be consumed by at least one other person. Therefore, the system provides a mechanism for the user to become connected to such other people. In the display of FIG. 10, the system provides a search field 156, an invite button 158, a friend requests list 160, and a friend list 162. The search field 156 allows the user to search for persons subscribing to the system with whom to connect. The invite button 158 provides a mechanism for the user to invite non-subscribers to subscribe to the system, and selection of the invite button 158 may cause the system to display an e-mail input field 164, as shown in FIG. 11, to permit the user to invite friends to join the system.

The friend requests list 160 may show invitations the user has extended to other subscribers to follow the other subscribers, requests that have been extended by other subscribers to follow the user, or both. The friend list 162 may show connections that have been established between the user and other subscribers.

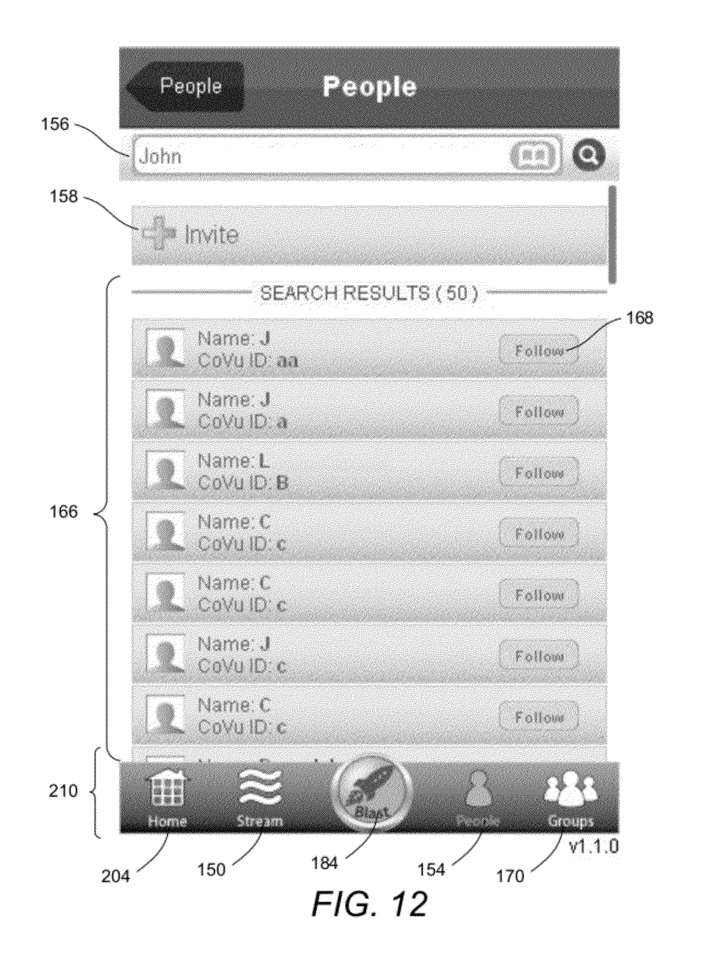

When the user searches for other subscribers using the search field 156, a display such as that shown in FIG. 12 may be provided by the system. As shown in FIG. 12, the user has input a search term into the search field 156, and the system has returned results of the search in a results list 166. The results list may provide the results of the search in any desired format, illustrated in FIG. 12 as displaying a subscriber name and a subscriber identification (both truncated in the given example) to permit the user to determine if any of the returned results is the person of interest. In some instances, actual photographs, videos, or audio information may be selectively provided to permit the user to better evaluate whether any of the results is the desired person. Each result includes a follow icon 168 that allows the user to request that the selected result be added to his or her friend list 162.

When the system receives selection of the follow icon 168, the system may respond in any of a variety of ways. As one example, the selected subscriber may be notified of the request (either through the subscriber's system or by any alternate form of communication, such as e-mail or text message), the request may be added to the selected subscriber's friend requests list 160, and a relationship might only be established upon approval of the friend request by the selected subscriber. Alternatively, a follower or friend relationship might be immediately established subject to ratification by the selected subscriber. Alternatively, a follower or friend relationship may be temporarily established and terminated if not ratified after a given length of time. As another alternative, the system may check settings previously specified by the selected subscriber to automatically determine whether or how to accept the friend or follow relationship.

Thus, for example, if a presenter plans to give a presentation to as broad an audience as possible, including persons with whom he had no previous relationship (e.g. the presentation is being advertised outside of the presenter's group of friends), he may wish to have the system automatically accept follow or friend requests during a period of time relevant to the presentation. The presenter might then instruct the system to automatically terminate the friend or follower relationship once the presentation has ended, may allow all new relationships to stand, may selectively ratify or reject any portion of the requests, or may take any other desired action.

Regardless, as friend or follower relationships are established through the system, the user becomes able to receive information from his or her friends and/or to transmit information to his or her friends. In some instances, a two-way relationship may be immediately established upon receipt of a friend or follower request. In other instances, a one-way (follower) relationship may be established upon receipt of a friend or follower request, and the relationship would only become two-way if the subscriber receiving the friend or follower request submits a return request or request to make the relationship two-way. The return request could be automatically accepted or the user might be provided with a notification and chance to accept or deny the request in any fashion as discussed above.

In some instances, it may become cumbersome to add friends or followers individually, or it may become cumbersome to manage the flow of information that is intended for many people on an individual basis. Therefore, embodiments of the invention facilitate working with groups of people. Thus, the screen shown in FIG. 8 may include a groups icon 170, and as friends or followers are listed in the friend list 162 of FIGS. 10 and 11, tools may be provided to facilitate grouping friends into groups.

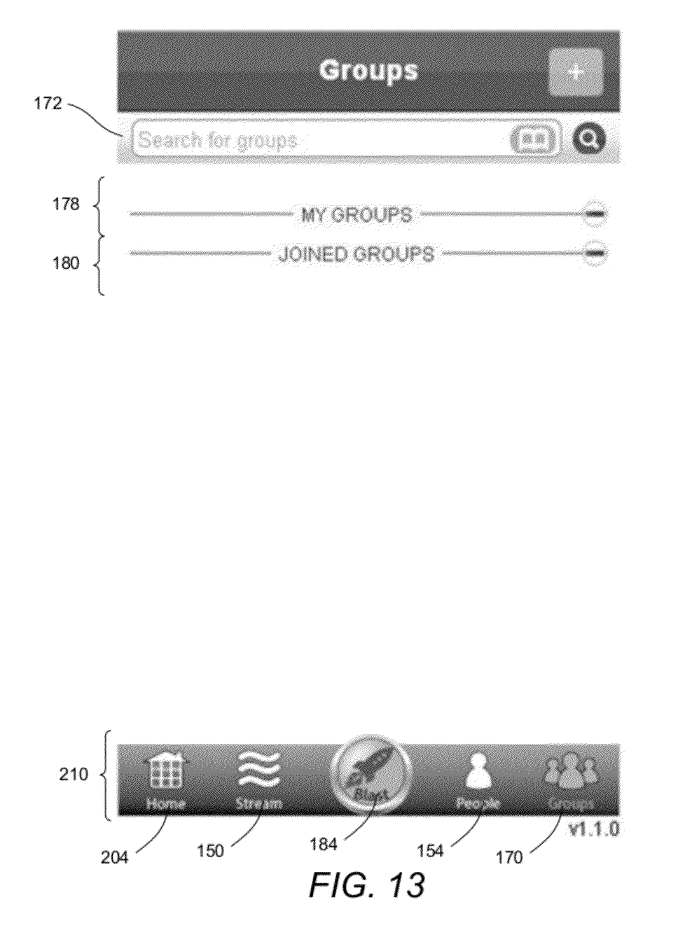

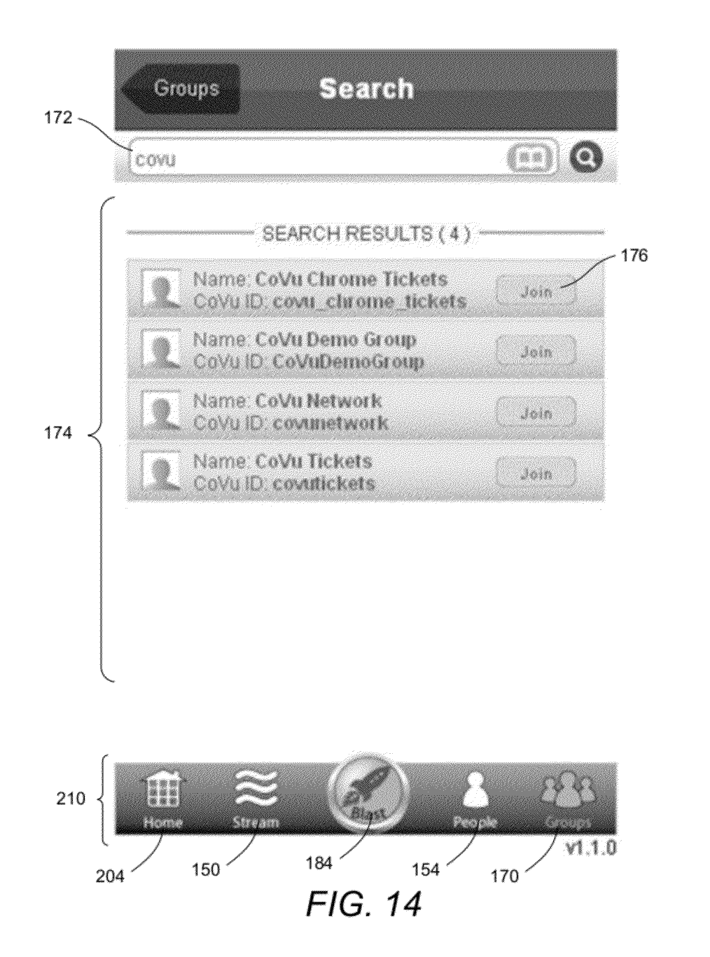

Selection of the groups icon 170 may cause the system to provide a display such as that shown in FIG. 13. As show in FIG. 13, the display includes a search field 172 similar to the search field 156 of FIG. 10-12. Inputting search terms into the search field 172 may cause a reaction similar to that discussed above with respect to a people search, and may cause the system display to change as illustrated in FIG. 14. In the display of FIG. 14, results of a search entered into the search field 172 returns relevant group results in a results list 174, providing information to the user (e.g. name, identifier, picture, media, etc.) to allow the user to determine whether any of the results are the desired ones, as discussed above. Each result in the results list 174 includes a join button 176 that allows the user to request to join the selected group.

Selection of the join button 176 may cause the system to react in any of a variety of ways similar to those discussed above with respect to selection of the follow icon 168. The result of the selection of the join button 176 may be governed by a moderator or creator of the selected group, for example, or by existing group settings previously provided to the system. The options available to respond to a join group request could be identical to or could be different from the options available to respond to a follow request. For example, in the presenter example discussed above, the presenter could create a group specific to the presentation, and could instruct the system to accept all requests to join the group. Subsequent to the presentation, the presenter could simply dissolve the group, and all connections to the group would be severed.

Group settings could be modified in any of a variety of ways. For example, upon acceptance into a group, the user might automatically become friends with all members of the group. Alternatively, the user might not even know who are the members of the group and would only be able to participate with the group as a group. As another alternative, the user might know who are members of the group and could exchange information with the group as a group, but would not automatically have a friend or follower status with individual group members. A group creator or moderator might be able to see which subscribers are group members, while members might not have such access. Messages to the group might, in some instances, need to be approved by a group creator or moderator before being distributed to the entire group. Any type of behavior associated with groups may be permitted by embodiments of the invention, and the foregoing examples are illustrative only.

As the user creates groups or becomes a moderator of groups, they may be added to a user's groups list 178 (shown empty in FIG. 13). Similarly, as the user joins others' groups, those groups may be added to a joined groups list 180 (also shown empty in FIG. 13). Selection of a group from the user's groups list 178 and/or from the joined groups list 180 may permit the user to take actions with respect to the selected group or groups, as discussed herein.

A variety of other options and features may be provided from the home screen of FIG. 8. Such options and features may be accessed by selecting one of a variety of other buttons 182. The other buttons 182 may provide access to the user's profile, to summary or dashboard information about the user or the user's account, to settings information, to help information, and/or to options for sharing information about the system with others, such as through social media sites and the like. While not all such options and associated screen displays are specifically illustrated in the Figure, it is anticipated that features of such options and screen displays will be readily appreciated by one of skill in the art.

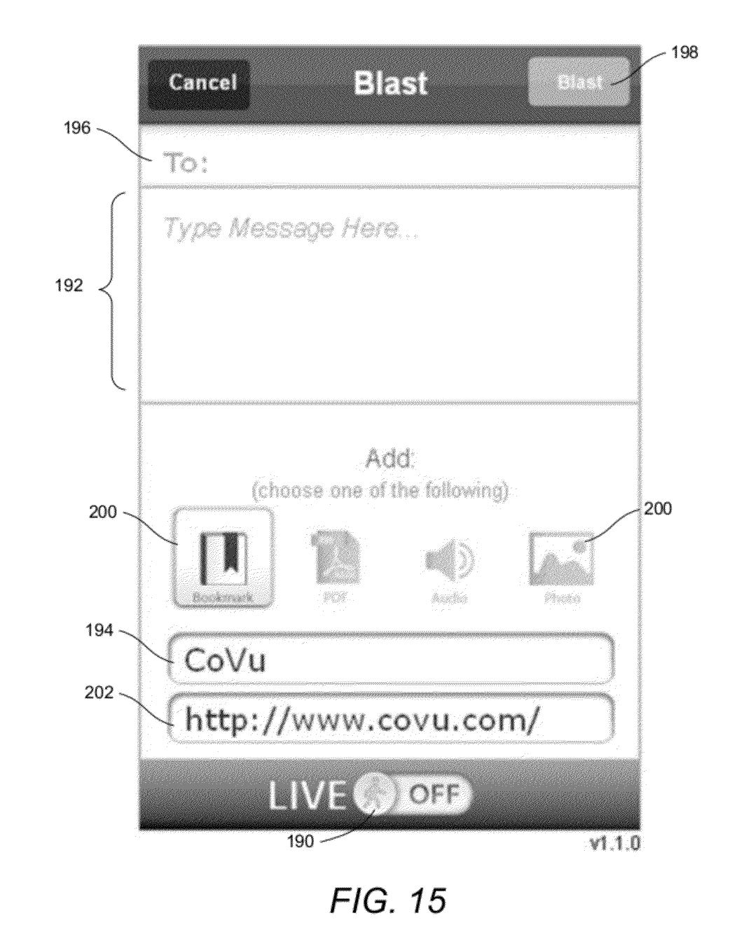

A blast button 184 is also provided on the home screen of FIG. 8, and selection of the blast button 184 may provide a screen display similar to that of FIG. 15. In this embodiment, selection of the blast button 184 allows a user to create a “blast” or transmission of information to one or more other users. The information transmitted may be self-contained information, or it may be the beginning of an open or “live” session. If the information is self-contained, it is received by appropriate subscribers (e.g. followers of the user) and is consumed and/or responded to by the recipients at any time they desire. If the information is the beginning of an open or live session, subscribers that join the session (e.g. by responding to an invitation sent as part of the blast) become live followers as discussed previously.

Thus, the display shown in FIG. 15 includes a “Live” selector 190. If the “Live” selector is in the “On” position, the blast is intended to be the start of a live session that may be joined by other users. If desired, additional information may be included in the “Live” blast, including a message, which may be input into a message field 192, a subject input into a subject field 194, and any other information or file. A recipient or recipients of the blast are input into a recipients field 196, and the blast is sent and the session opened by selecting a send blast button 198. The recipient or recipients may be individuals or groups. Recipients then receive a notification or invitation as discussed herein, and can join the live session, also as discussed herein.

If, however, a live session is not intended, the “Live” selector may be left in or switched to an “Off” position, and the transmission sent to one or more other users or groups becomes a non-live transmission to be consumed or responded to at the recipients' discretion and timing. The transmission may include a message entered in the message field 192, a subject entered into the subject field 194, or any of a variety of files or other information. For example, one or more attachment selectors 200 may be provided to allow the user to select one or more attachments to include with the transmission. Any type of attachment known in the art may be included. Selection of the appropriate attachment selector 200 may cause the system to provide an appropriate dialog box, as known in the art, to permit the user to attach the desired attachment(s).

One particular type of attachment that may differ from attachments commonly sent by standard communication methods (e-mail, text message, etc.) is an attachment of a bookmark. Therefore, FIG. 15 shows a bookmark/attachment field 202. The bookmark/attachment field 202 may allow a user to view or modify attachments to the transmission, including any bookmarks (e.g. URLs) desired to be shared as part of the transmission. While the user may simply enter in the bookmark or URL to be shared into the bookmark/attachment field 202, the integration of the system with the user's browser may permit a more sophisticated interaction.

Thus, if the user selects a “Bookmark” attachment selector 200, the system may automatically discover a URL to which the user's then-active browser window or browser tab is currently directed, and could automatically insert the URL into the bookmark/attachment field 202. This could greatly simplify the process by which the user could share interesting information that comes to the user's attention. For example, the user could be browsing using the browser, as normal. Upon encountering a web page of interest, the user could simply select the browser extension icon 72, causing the system to display a display similar to any of FIGS. 8-15. The user could then select the blast button 184, followed by selection of the “Bookmark” attachment selector 200, which would automatically fill the bookmark/attachment field 202 with the URL to which the browser was directed. The user would then only add any message information and recipient information, and could then quickly and easily send the URL information to any desired recipients.

As is commonly known in the art, there are certain features of the system that may be more commonly accessed than other features. Therefore, in at least some displays provided by the system, a commonly-accessed features bar 210 may be provided, as illustrated in FIGS. 9-14. The commonly-accessed features bar 210, for example, may include copies of the stream icon 150, the people icon 154, the groups icon 170, and the blast button 184, and may also include a home icon 204 to facilitate return to the home screen of FIG. 8. The commonly-accessed features bar 210 may be provided on all displays, some displays, or no displays, as desired for the particular embodiment.

The features and uses of embodiments of the invention discussed herein are merely illustrative of the advantages and uses of embodiments of the invention, and are not limited to the specifics provided herein. The scope of the invention is not limited by the specifically-illustrated examples, but is to be determined from the appended claims. Other non-limiting examples of uses and advantages of the embodiments of the invention include systems facilitating audience participation: a leader-follower relationship may permit polling of an “audience,” as well as messaging back and forth during a live presentation between a presenter and an audience. Embodiments of the invention may allow followers to add annotations to a followed session, and may even facilitate following of a session and/or annotations by allowing a follower to effectively pause a presentation, such as to allow a web site to load, to allow annotations or notes to be added by the follower, or the like.

Embodiments of the invention may be utilized to customize the view presented to followers through the followers' browser, such that the followers' views may differ from the view of the leader and, potentially, from the views of different followers. For example, embodiments of the invention may permit the insertion of advertisements, as appropriate, into the view presented to followers. The insertion of advertisements may include the insertion of advertisements targeted to the followers, and the followers may opt into viewing of advertisements and/or targeted advertisements using embodiments of the invention. For example, the system may detect a web page that includes a banner advertisement of a particular size, for example, 300 by 250 pixels. When such an advertisement is detected, the system may either replace it with a targeted advertisement, or may simply add an additional similarly-sized but targeted advertisement that displaces the existing advertisement downward in the display. The provision of advertisements and/or targeted advertisements in this fashion may serve as a revenue stream to the service provider. Advertisements may be targeted based on preferences of the individual followers, preferences of the leader, groups with which the leader and/or follower is affiliated in the system, or according to any other appropriate targeting method.

Embodiments of the invention may permit device interactivity with the surrounding world in a way not currently possible. For example, a store display may include an identifier allowing a smart phone user to join a live session in progress. Upon joining the live session, the user might be able to access audio and/or video information corresponding to the store display, which might enhance the store display or changes to the store display. Similarly, movie goers could join a live session associated with a movie feature or associated with a pre-feature program, thereby enhancing the movie feature or pre-feature experience. Thus, during the movie feature or pre-feature, the users' mobile devices might participate in the movie feature or pre-feature by vibrating, producing feature-related sounds and/or lights, and the like. The foregoing are merely examples of ways in which embodiments of the invention may be used and are intended to illustrate ways in which embodiments of the invention may be extended beyond merely allowing users to co-browse through the Internet.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A computer-implemented method for sharing online information between computer systems comprising:
monitoring information at a leader computer related to a status of the leader computer;
passing a uniform resource locator (URL) associated with a status of the leader computer from the leader computer to a follower computer over a computer network; and
automatically causing a browser window at the follower computer to be directed to the URL upon receipt of the URL over the computer network.

2. A method as recited in claim 1, wherein the status of the leader computer comprises a URL to which a browser window of the leader computer is directed.

3. A method as recited in claim 2, wherein each time the browser window of the leader computer is directed to access a different URL, the browser window of the follower computer is automatically directed to access the different URL.

4. A method as recited in claim 3, wherein an additional action relating to a website being accessed by the browser window of the leader computer is received and information relating to the additional action is passed to the browser window of the follower computer.

5. A method as recited in claim 4, wherein the additional action comprises one of:
movement of a pointer within the browser window of the leader computer;
interaction with a website element displayed within the browser window of the leader computer; and
input of password information to a website being accessed by the browser window of the leader computer.

6. A method as recited in claim 1, wherein passing of a URL occurs through an Internet-connected service provider providing a session connecting the leader computer to the follower computer.

7. A method as recited in claim 1, wherein a browser extension is installed in the browser program of each of the leader computer and the follower computer, and wherein the browser extensions pass the URL and cause the browser window of the follower computer to be directed to the URL.

8. A method as recited in claim 1, wherein the information related to the status of the leader computer comprises a screen shot taken at the leader computer, the method further comprising:
uploading the screen shot taken at the leader computer to a website; and
creating a webpage displaying the screen shot and having a unique URL dedicated to the webpage displaying the screen shot, wherein the unique URL dedicated to the webpage displaying the screen shot is the URL passed from the leader computer to the follower computer.

9. A method as recited in claim 8, wherein the screen shot comprises one of:
a screen shot of the browser window of the leader computer; and
a screen shot of an area of display including information other than just the browser window of the leader computer.

10. A method as recited in claim 1, wherein the follower computer is one of a plurality of follower computers, each receiving the URL and each having a browser window which is automatically caused to be directed to the URL upon receipt of the URL.

11. A computer-implemented method for sharing a browser session between remote computer systems comprising:
establishing a communicative leader-follower session between remote computer systems over a network, wherein a browser window on a first computer system of the remote computer systems becomes a leader browser, and wherein a browser window on a second computer system of the remote computer systems becomes a follower browser;
monitoring the leader browser window for inputs changing a URL being accessed by the leader browser;
detecting an input changing the URL being accessed by the leader browser to a new URL;
automatically communicating the new URL over the network to the second computer system; and
automatically causing the follower browser to access the new URL upon receipt of the new URL by the second computer system.

12. A method as recited in claim 11, wherein the new URL is transmitted from the first computer system by a browser extension and is received at the second computer system by a browser extension.

13. A method as recited in claim 11, wherein a communicative connection is established between a location of the first computer system and a location of the second computer system to facilitate communication between the respective locations other than by the changing of the accessed URL, the communicative connection comprising one of:
a one-way audio connection;
a two-way audio connection;
a one-way connection for the transmission of textual information;
a two-way connection for the transmission of textual information;
a one-way visual connection;
a two-way visual connection;
a one-way audio-visual connection; and
a two-way audio-visual connection.

14. A method as recited in claim 11, wherein a time shift is provided between the step of detecting an input changing the URL being accessed by the leader browser to a new URL and the step of automatically causing the follower browser to access the new URL.

15. A method as recited in claim 11, wherein a service provider provides and maintains the communicative leader-follower session between the remote computer systems.

16. A method as recited in claim 11, further comprising causing the follower browser to become a new leader browser while causing the leader browser to become a new follower browser such that changes in a URL being accessed at the new leader browser are automatically caused to be accessed at the new follower browser.

17. A method as recited in claim 11, wherein a plurality of nested leader-follower sessions may be simultaneously established such that a follower browser in one leader-follower session may serve as a leader browser in a different leader-follower session.

18. A method as recited in claim 11, wherein a history of URLs visited during a session is maintained at the second computer system to facilitate later access of the URLs visited within the leader-follower session including after the leader-follower session has been terminated.

19. A method as recited in claim 11, further comprising:
receiving a request from the first computer system to establish the leader-follower session with the leader browser leading the session; and
receiving a request from the second computer system to join the leader-follower session with the follower browser following the session.

20. A non-transitory computer-readable medium storing computer program code for causing a computer to implement a method for sharing a browser session between remote computer systems comprising:
establishing a communicative leader-follower session between remote computer systems over a network, wherein a browser window on a first computer system of the remote computer systems becomes a leader browser, and wherein a browser window on a second computer system of the remote computer systems becomes a follower browser;
monitoring the leader browser window for inputs changing a URL being accessed by the leader browser;
detecting an input changing the URL being accessed by the leader browser to a new URL;
automatically communicating the new URL over the network to the second computer system; and
automatically causing the follower browser to access the new URL upon receipt of the new URL by the second computer system.
